(19) United States
(12) Patent Application Publication
(10) Pub. No.: US 2014/0131376 A1
(43) Pub. Date: May 15, 2014

(54) DEVICE FOR DELIVERING BY LAUNCH PRODUCTS FROM A VENDING MACHINE

(71) Applicant: Luigi FAGLIA, COLLEBEATO (IT)

(72) Inventor: Luigi Faglia, Collebeato (IT)

(21) Appl. No.: 14/119,937

(22) PCT Filed: May 24, 2012
(86) PCT No.: PCT/IB2012/052611

§ 371 Date: Jan. 30, 2014

(30) Foreign Application Priority Data
Jun. 1, 2011 (IT) BS2011A000082

(51) Int. Cl. G07F 11/16

(52) U.S. Cl. CPC G07F 11/16
USPC 221/1; 221/192

(57) ABSTRACT

A device (1) for delivering products from a vending machine (100), a vending machine (100) comprising such device and a method for delivering products from a vending machines, wherein the device comprises a base (2) destined to be mounted to the vending machine, a housing body (5) movably mounted to the base and destined to receive, at a first vertical height (11), a first product (10) to be delivered, and delivering members (20) interposed between the base and the housing body and structured for moving the housing body in order to determine the delivering of the product, wherein the delivering of the product is done by means of a launch ejection of the product to outside the vending machine along a launch trajectory which passes through a second vertical height (12) that is higher than the first vertical height.

The present invention relates to a device for delivering (or dispensing) products from a vending machine, a vending machine of products comprising such device and a method for delivering products from a vending machine.

Automatic vending machines are known which are able to provide products on request by a user, typically after payment of a sum of money. These vending machines can contain a wide variety of products, for example drinks, snacks, newspapers, cigarettes, etc. The vending machines internally contain, in a store, one or more types of products available to the user, and show externally an indication of the respective price of each type of product. In some vending machines the store is constituted by horizontal shelves, on which the products are located, typically arranged in homogeneous rows by product type or by price, visible to the user through a transparent wall on the front side of the vending machine. Alternatively the store can comprise internal compartments, typically not visible from outside, in which the products are stored, for example separated by type.

The vending machine typically comprises an external interface for selecting and paying for the desired product (for example a keyboard, a display and a slot for inserting cash or for the use of cards or keys having a prepaid credit) and an internal collecting chamber, in the lower part of the vending machine, in which the selected product is positioned for the withdrawal by the user. Typically the user manually collects the product via a hatch, on an external side of the vending machine, from which the user accesses the collecting chamber. In this way the user cannot access the store or other internal parts of the vending machine, with the exception of the collecting compartment.

Also known are different ways of transferring the products from the respective position in the store to the collecting compartment, where collection can be made. Typically, in the case of a store having shelves, the product selected by the user is pushed, by means of special movement members activated following selection and payment for the product, up to the front end of the respective shelf (for example of the respective row), such as to cause the fall from the shelf and the depositing in the underlying collecting compartment, which is in the low part of the vending machine. Alternatively, for example in a case in which the vending machine contains fragile or delicate products, the transfer from the respective shelf to the collecting compartment is done by an elevator able to be positioned on the correct plane, collect the product pushed to the end of the shelf, descend to the collecting compartment and deposit the product there. Again, in vending machines having a store provided with internal compartments, the passage of the product from the respective internal compartment to the collecting compartment is done by special movement means which push, transport or convey the desired product into the collecting compartment.

The Applicant has however found that vending machines presently available are not without drawbacks and can be improved upon in various ways.

In particular, the Applicant believes that the need, in known vending machines, to manually access the internal compartment means that the operations of delivering a product from a vending machine is characterised by a certain degree of complexity. In fact, the collecting compartment is typically positioned in the low part, as the products coming from the store have to be accommodated therein, for example by falling from the respective shelf or internal compartment, and as it has to be guaranteed that the user cannot access in an unauthorised way to the overlying store. This mode of distributing forces the user to assume an uncomfortable pose in order to collect the product. Again, the positioning of the collecting compartment internally of the vending machine and the conformation of the hatch and the compartment itself can also cause the product to get jammed during the collecting step.

In general, the collection of a product from the vending machines typically requires a considerable amount of time.

In this situation the aim underpinning the present invention, in its various aspects and/or embodiments, is to make available a device for delivering products from a vending machine, a vending machine comprising such device and a method for delivering products from a vending machine which can obviate one or more of the mentioned drawbacks.

In particular, one of the aims of the present invention is to disclose a device for delivering products from a vending machine which operates according to new functioning modes that are different with respect to known vending machines.

A further aim of the present invention is to provide a device for delivering which enables rationalising and making the delivering of products from a vending machine more efficient.

A further aim of the present invention is to provide a device for delivering products from a vending machine, which device enables an increase in simplicity of the operations of delivering and/or a reduction in the time required for delivering a product.

One or more of the aims, or others besides, which will more clearly emerge from the following description, are substantially attained by a device for delivering products from a vending machine, by a vending machine of products, comprising such device, and by a method for delivering products from a vending machine having the technical characteristics contained in one or more of the accompanying claims, each of which can be taken by itself (without the dependent claims) or in any combination with the other claims, as well as according to the following aspects and/or example embodiments, variously combined, including with the above-mentioned claims.

In an aspect of the invention, the invention relates to a device for delivering products from a vending machine, comprising:
a base destined to be mounted to the vending machine and to receive a product to be delivered;
delivering members active on said base and structured for determining the delivering of the product.

In an aspect, the base is destined to receive the product to be delivered at a first vertical height and the delivering of the product is done by launch ejection of the product directly to outside the vending machine along a launch trajectory which passes through a second vertical height, higher than said first vertical height.

In an aspect, the invention relates to a device for delivering products from a vending machine, comprising:
a base destined to be mounted to the vending machine;
a housing body movably mounted to said base and destined to receive, at a first vertical height, a first product to be delivered;
delivering members interposed between said base and said housing body and structured such as to move the housing body in order to determined delivering of the product,
   wherein the delivering of the product is done by means of a launch expulsion of the product to outside the vending machine along a launch trajectory which passes through a second vertical height that is greater than said first vertical height.

The Applicant believes that the combination of the above technical characteristics, in particular the presence of delivering members interposed between the base and the housing body and structured to move the housing body in order to determine delivering of the product, and the fact that the delivering is attained by launch ejection of the product directly externally of the vending machine along a launch trajectory that passes through a second vertical height that is greater than the first vertical height, enables simplification, rationalisation and/or acceleration of the delivering of the product, and enables the product to be made available to the user in a practical way.

The Applicant believes that, differently to known vending machines, in which the user must intervene manually internally of the vending machine itself in order to collect the product, the vending machine of the present invention enables delivering the products directly externally of the vending machine and limiting the manual operations performed by the user, in particular internally of the vending machine.

Therefore the device and the vending machine of the present invention operate in a completely different way with respect to the devices and vending machines belonging to the prior art.

The Applicant believes to having provided an original technical solution applicable to the technical sector of automatic vending machines and, in particular, of the delivering machines of products from a vending machine. Such technical solution enables, the Applicant believes for the first time, complete automation of the delivering of a product from a vending machine, bringing the product from internal store of the vending machine to the outside thereof. Also, the Applicant believes that the above-mentioned technical characteristics enable improving the user-vending machine interaction, increasing the user's attention level with regard to the product, from inside to outside the machine during the delivering operation.

In an aspect, the housing body is mobile between a first position, in which it receives and houses a product, and a second position, distinct from the first.

In an aspect, the delivering members are structured such as to pass between a rest configuration, in which they position the housing body in said first position, and a launch position, in which they position the housing body in said second position.

In an aspect, the delivering is carried out from a delivering mouth located in proximity of the top of the vending machine. In an aspect, the base comprises a horizontal platform bearing the delivering members, on which the housing body is mounted in a higher position than the base, and the passage of the delivering members between the rest configuration and the launch configuration determines a vertical translation of the housing body respectively nearing to and distancing from the platform.

In an aspect, the base comprises a fixed support and translating members mounted to the fixed support and bearing the platform, the translating members being structured such as to horizontally move the platform between a third position, in which it is neared to the fixed support, and a fourth position, in which it is distanced from the fixed support.

In an aspect, the platform, when in the third position, is positioned such as to receive a product from the vending machine store and, when in the fourth position, is positioned in such a way as to launch the product into a launch conduit. The Applicant sustains that the technical characteristic of moving the housing body between the third and the fourth position enables collecting the product in an internal position of the vending machine and delivering the product, via the launch conduit, in a trajectory that begins from a different position.

In this way, should a foreign object be introduced into the launch conduit, via an outlet of the conduit, the object would not end up on the housing body, as the housing body is normally in the third position and moves into the fourth position (to a lower mouth of the conduit) only when the product is launched, thus preventing the possibility that the foreign object will thereafter be launchingly ejected from the delivering device.

The characteristics of the launch conduit will emerge more fully from the following description.

In an aspect, the invention relates to a vending machine of products, comprising:
a container body;
a store positioned in the container body and structured such as to removably house a plurality of products;
a delivering mouth placing the inside of the vending machine in communication with the outside;
a device for delivering products, positioned in the container body and structured such as to receive from the store, at the first vertical height, a product to be delivered and to deliver the product by launch ejection of the product from the delivering mouth to outside the vending machine along a launch trajectory passing through the second vertical height that is higher than the first vertical height.

In an aspect the vending machine comprises a device for delivering according to one or more of the above aspects and/or the claims.

In an aspect, the delivering device is positioned at the lower part of the vending machine in order to receive, on the housing body, the products coming from the store positioned in the upper part thereof, and wherein the delivering is done from the delivering mouth located in proximity of the top thereof.

In an aspect, the invention relates to a method for delivering products from a vending machine, which method comprises steps of:

a) receiving, at a first vertical height, a product to be delivered from a store of the vending machine;

b) delivering the product by launch ejection thereof externally of the vending machine along a launch trajectory that passes through a second vertical height that is higher than the first vertical height.

In an aspect, steps a) and/or b) are realised with a delivering device according to one or more of the aspects and/or the claims.

In an aspect, during step a) the product to be delivered is received on a housing body in a first position and in step b) the delivering is done by passage of the housing body into a second position, distinct from the first, in which the product is distanced from the housing body in order to perform a motion along the launch trajectory, with a consequent exit of the product from the vending machine.

In an aspect the launch trajectory is according to one or more of the aspects and/or the claims.

In an aspect, in step b) the delivering is done from a delivering mouth of the vending machine located in proximity of the top of the vending machine.

Further characteristics and advantages will more fully emerge from the detailed description that follows of some embodiments, among which also a preferred embodiment, in the form of non-exclusive examples of a device for delivering products from a vending machine and a vending machine of products comprising the device according to the present invention. The description will be made in the following with reference to the accompanying drawings, provided merely by way of non-limiting example, in which:

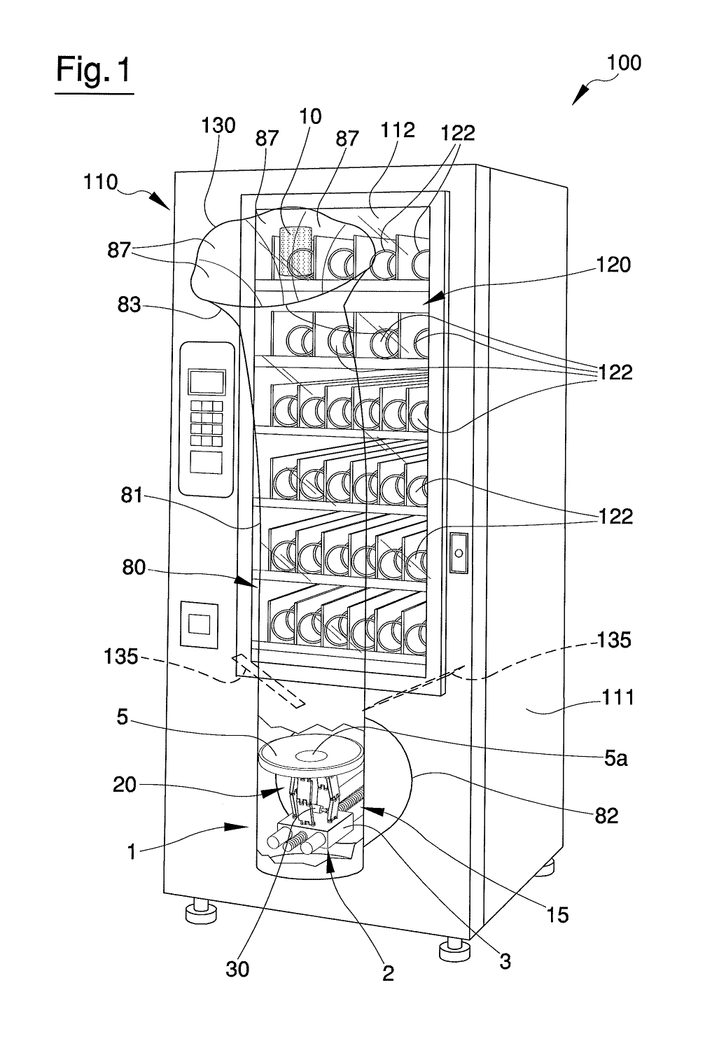

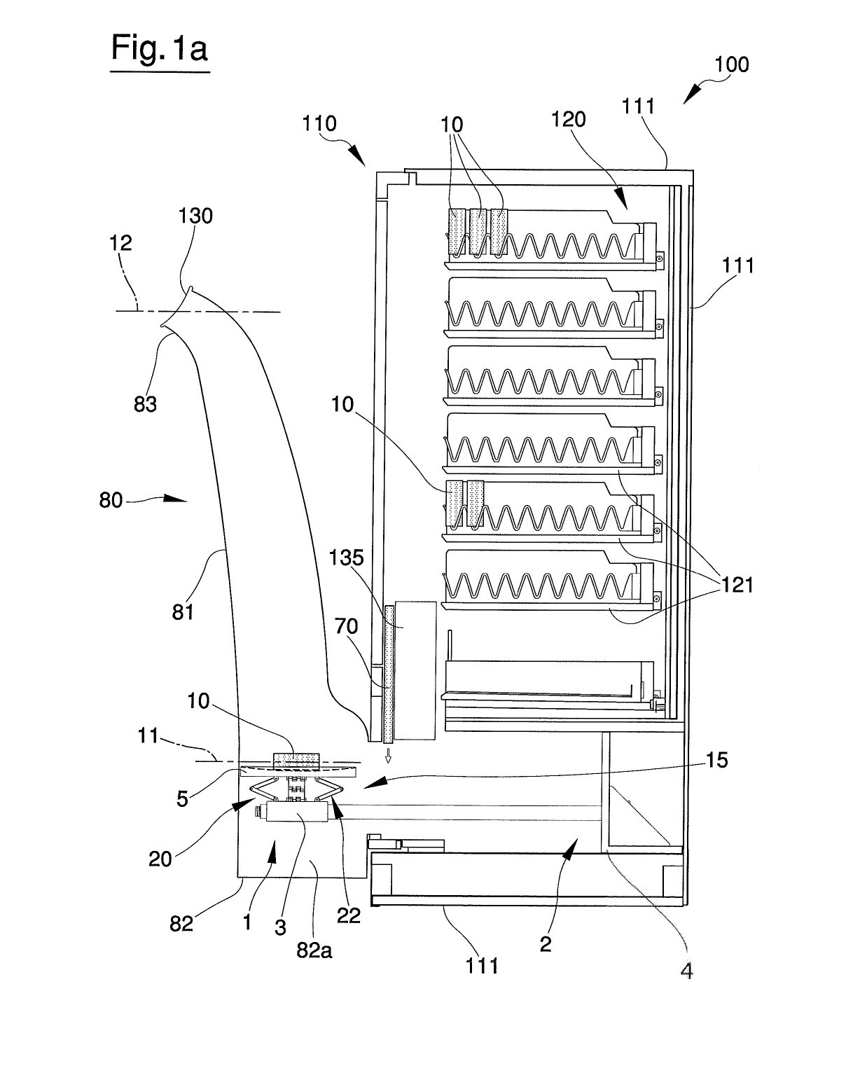

FIG. 1 is a schematic perspective view of a possible embodiment of a vending machine according to the present invention, comprising a possible embodiment of a device for delivering products according to the present invention;

FIG. 1a is a schematic lateral view of the vending machine of FIG. 1, with some parts removed;

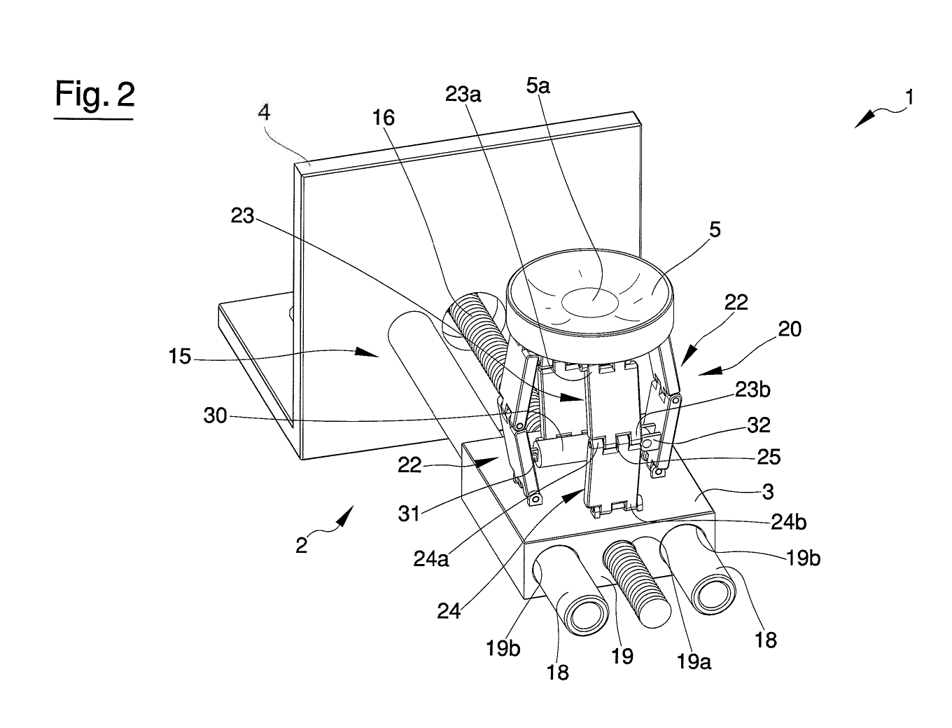

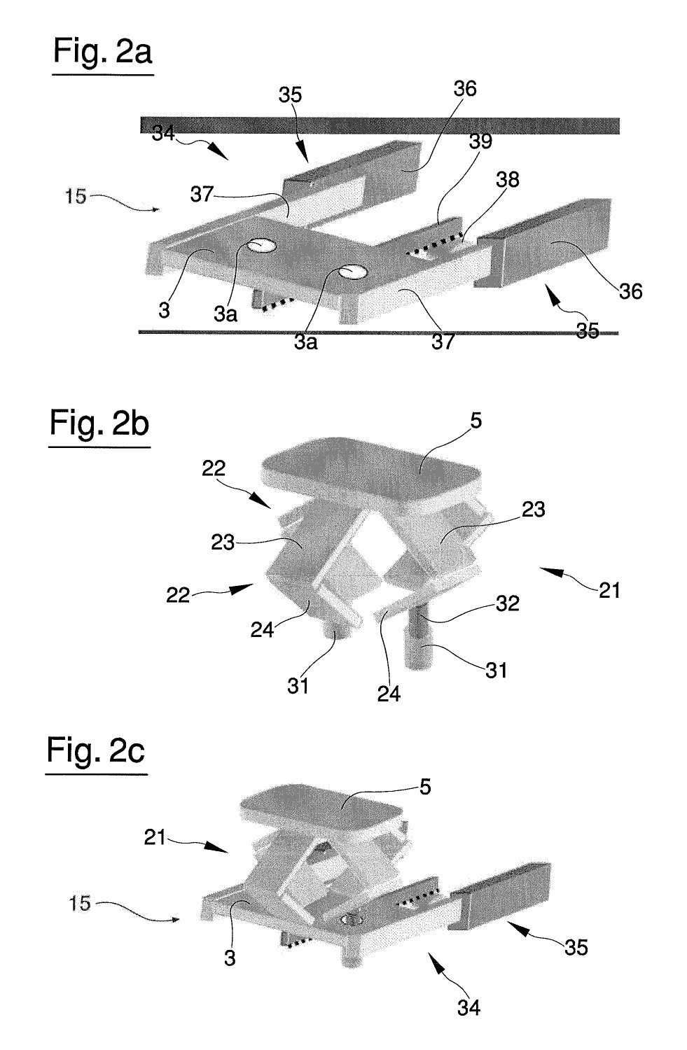

FIG. 2 is a perspective view of the product delivering device of FIGS. 1 and 1a;

FIGS. 2a and 2b are schematic perspective views of some parts of a possible embodiment of a device for delivering products according to the present invention;

FIG. 2c is a schematic perspective view of the parts shown in FIG. 2b, mounted on the parts shown in FIG. 2a;

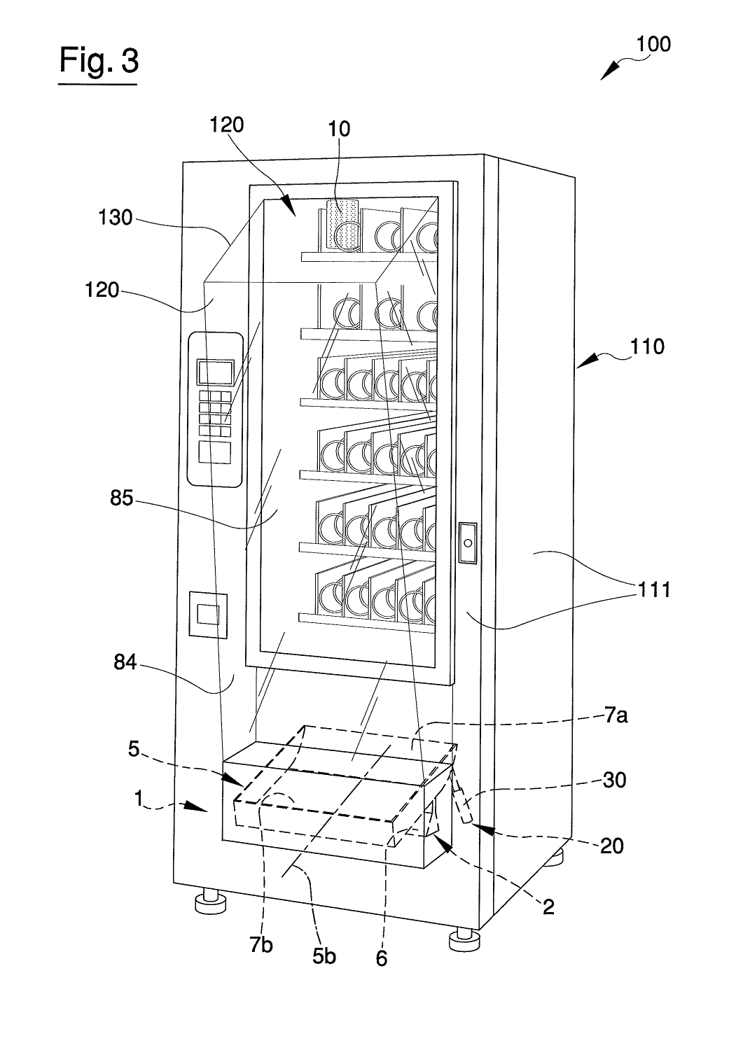

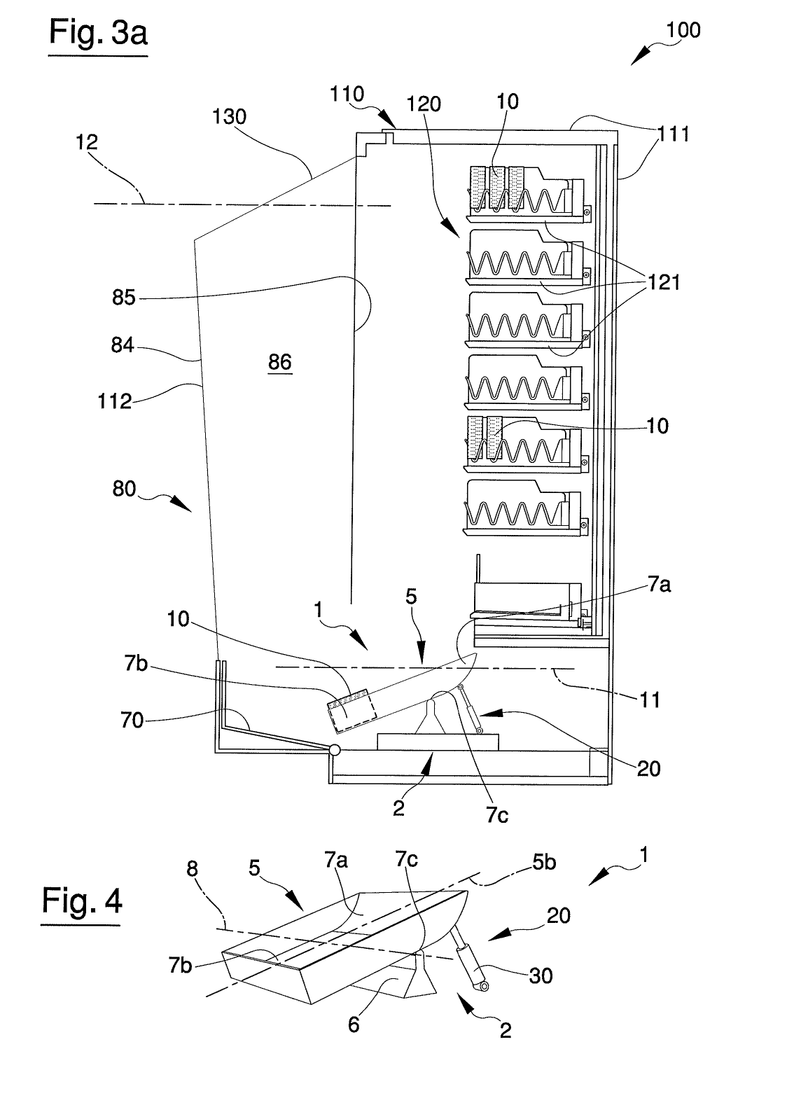

FIG. 3 is a schematic perspective view of a further possible embodiment of a vending machine according to the present invention, comprising a further possible embodiment of a product delivering device according to the present invention;

FIG. 3a is a schematic lateral view of a vending machine according to the present invention, with some parts removed;

FIG. 4 is a perspective view of the product delivering device of FIGS. 3 and 3a;

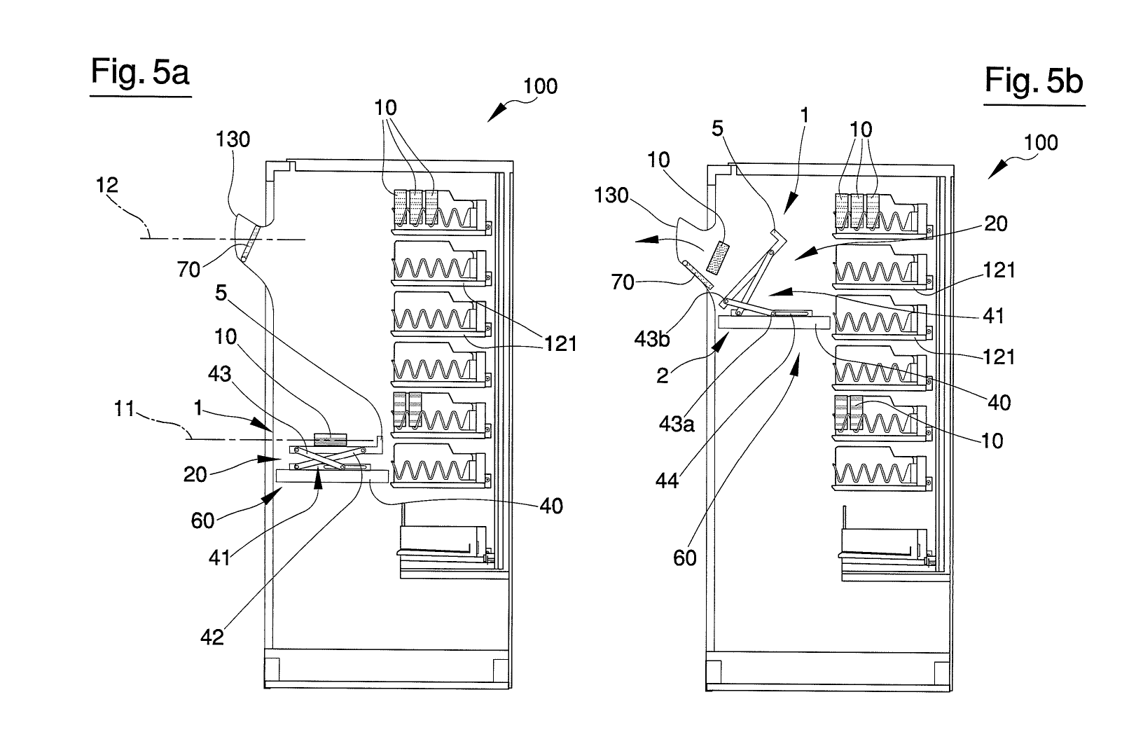

FIG. 5a is a schematic lateral view of a further embodiment of a vending machine according to the present invention, with some parts removed, comprising a further possible embodiment of a product delivering device of the present invention, in an operating position;

FIG. 5b is a schematic lateral view of the vending machine of FIG. 5a in a further operating position;

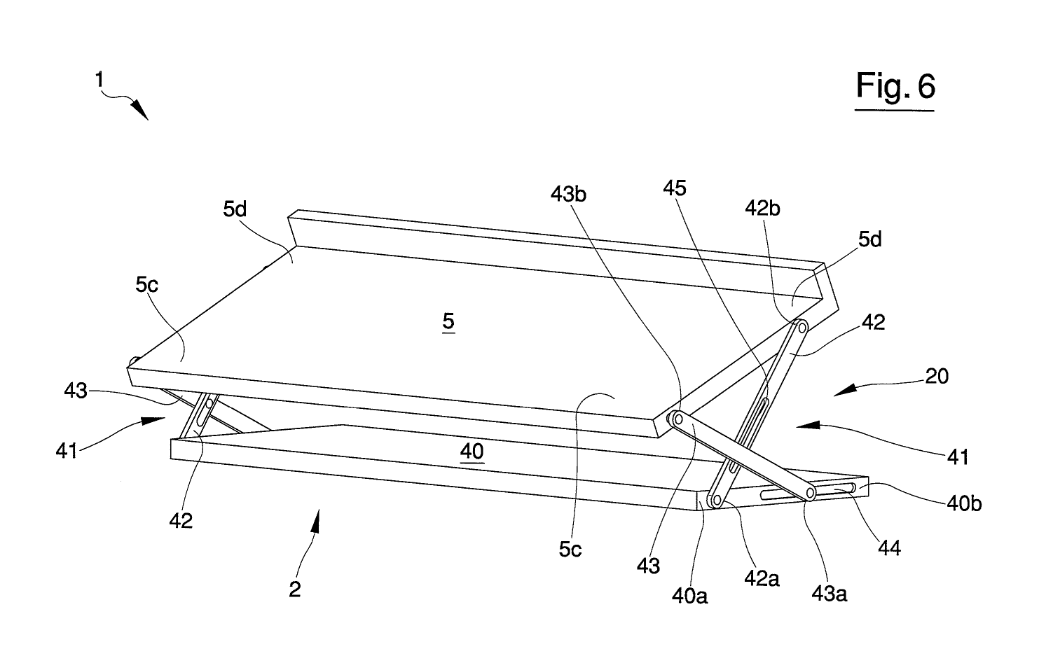

FIG. 6 is a perspective view of the product delivering device of FIGS. 5a and 5b.

With reference to the figures, a device for delivering products from a vending machine and a vending machine according to the present invention are denoted in their entirety, respectively, with reference numbers 1 and 100. In general, the same reference numeral is used for the same elements, including in the variant embodiments thereof.

The product vending machine 100, as shown in the embodiments of FIGS. 1 and 1a, 3 and 3a, 5a and 5b, comprises a containing body 110, a store 120 positioned in the container body and structured such as to removably house a plurality of products 10, a delivering mouth 130 setting the inside of the vending machine in communication with the outside, and a product delivering device 1 positioned in the container body and structured such as to receive, at a first vertical height 11, a product to be delivered from the store and such as to deliver it from the delivering mouth by means of launch ejection directly to the outside of the vending machine along a launch trajectory which passes through a second vertical height 12, higher than the first vertical height.

The store 120 preferably comprises a plurality of horizontal shelves 121, each located at a respective vertical level, or (in an embodiment that is not illustrated) can comprise a plurality of internal compartments. Each shelf preferably comprises a plurality of parallel rows 122. Each shelf and/or row and/or internal compartment is typically destined to contain a respective type of product.

The containing body 110 is preferably closed with the exception of the delivering mouth and comprises a plurality of walls 111. A front wall 112 of the plurality of walls is preferably at least partially transparent, for example in order to enable the user to see one or more products contained in the store.

Preferably, as shown in the figures by way of example, the store is positioned superiorly of the delivering device of a product from the store to the device itself is done by free fall. The store 1120 preferably comprises movement members 125 structured such as to determine the movement of the product from the respective position in the store up to the delivering device (for example to determine the mentioned fall) through the passage into an internal channel or an internal space. By way of example, the movement members comprise screw conveyors 126, each associated to a respective row 122 of a shelf.

The vending machine preferably comprises a chute 135 (preferably having a funnel shape) conformed such as to convey the product coming from the store towards the delivering device.

The delivering device 1 of products from the vending machine, in the different embodiments shown in the figures, comprises a base 2 destined to be mounted in the vending machine, a housing body 5 movably mounted on the base and destined to receive, at the first vertical height 11, a product 10 to be delivered, and delivering members 20 interposed between the base and the housing body and structured such as to move the housing body and determine delivering of the product. Such delivering of the product is done by launch ejection of the product directly externally of the vending machine along a launch trajectory that passes through the second vertical height 12 that is higher than the first vertical height.

Preferably, the housing body is mobile between a first position (shown by way of example in FIGS. 1a, 3a and 5a), in which it receives and houses a product, and a second position (for example shown in FIGS. 1, 2, 5b and 6), distinct from the first, in which the product distances from the housing body in order to perform the delivering.

Preferably, the delivering members 20 are structured such as to pass between a rest configuration, in which they position the housing body in the first position, and a launch configuration, in which they position the housing body in the second position.

Preferably, the passage of the delivering members between the rest configuration and the launch configuration is substantially sharply done, such that the product distances from the housing body in order to perform the delivering.

Preferably, the passage of the members 20 from the rest configuration to the launch configuration determines the detachment, substantially immediately, of the product housed in the housing body and the movement thereof along the launch trajectory, with a consequent exiting of the product from the vending machine.

Preferably, the mentioned launch trajectory comprises an ascending fraction, having an initial point lying on the housing body and a terminal point, and the ascending fraction passes through, or has the terminal point at, the second vertical height 12.

Preferably, the launch trajectory comprises a descending faction, following and continuing with the descending fraction, having an initial point coinciding with the terminal point of the ascending fraction and a respective terminal point external of the vending machine and at a vertical height that is lower than the second vertical height 12.

The ascending fraction is preferably substantially internal of the vending machine and the descending fraction is substantially (completely) external of the vending machine.

In a possible embodiment (not illustrated) the trajectory can comprise only the descending fraction and the respective initial point coincides with the second vertical height 12.

Preferably, as shown in the figures, the delivering mouth 130, from which the delivered product exits, is positioned in proximity of the top of the vending machine (for example on the upper portion of the front wall 112).

Preferably, the delivering device is structured such as to be positioned at the lower part of the vending machine and to receive, on the housing body 5, the products coming from the store of the vending machine positioned in the upper part thereof, preferably conveyed by the chute 135.

Preferably, in a possible embodiment shown in FIG. 1, 1a and in particular in FIG. 2, the base 2 comprises a horizontal platform 3 bearing the delivering members 20, on which the housing body 5 is mounted in a position above the base, and the passage of the delivering members between the rest configuration and the launch configuration determines a vertical translation of the housing body respectively nearingly to and distancingly from the platform.

Preferably, the housing body 5 comprises a cavity 5a, on an upper surface, defining a seating conformed such as to house the product.

Preferably, the delivering members comprise an articulated structure 21, connecting the platform and the housing body, and at least an activating member 30 operatively connected to the articulated structure and structured such as to determine the passage between the rest configuration and the launch configuration.

Preferably, the articulated structure comprises at least an arm 22 comprising an upper rod 23, a lower rod 24 and a central hinge 25, the upper rod and the lower rod forming between them an internal angle that is less than or equal to 180°. The upper rod preferably has an upper end 23a hinged to the housing body and a lower end 23b hinged to the central hinge, and the lower rod has a respective upper end 24a hinged to the central hinge, and a lower end 24b hinged to the platform 3.

Preferably, the central hinge has a rotation axis that is perpendicular to the vertical translation of the housing body; the rotation axis is preferably horizontal.

Preferably, the upper end 23a of the upper rod and the lower end 24b of the lower rod have one, and preferably one only, degree of rotational freedom and are able to rotate about a respective horizontal rotation axis that is fixed with respect to the platform 3.

The nearing and the distancing of the housing body to and from the platform respectively determine a reduction and an increase in the internal angle between the upper and lower rods, to which correspond respectively a closing and an opening of the arm. The nearing of the housing body 5 to the platform 3 determines a translation of the upper end 23a of the upper rod downwards and a translation of the central hinge 25 downwards and horizontally (externally or internally of the space comprised between the housing body and the platform).

The distancing of the housing body from the platform determines a translation of the upper end 23a of the upper rod upwards and a translation of the central hinge upwards and horizontally (externally or internally of the space comprised between the housing body and the platform), in equal and opposite motions to the motion determined by the nearing of the housing body to the platform. The position of the lower end 24b of the lower rod remains unchanged during the nearing and the distancing of the housing body from the platform.

Preferably, the upper rod 23 and the lower rod 24 are identical to one another. This enables obtaining an articulated structure made up of modular and/or simple and/or economical components.

Preferably, as shown by way of example in FIG. 2, the activating member 30 has a first end 31 fixed to an arm and a second end 32, opposite the first end, fixed to a further arm, preferably in an opposite position in the articulated structure, preferably by means of appropriate rotating joints (for example hinges).

Preferably, the delivering members 20 can comprise a plurality of activating members 30, for example one for each arm, preferably activatable simultaneously and cooperating in the passage between the rest configuration and the launch configuration.

Preferably, the activating member is structured in such a way that the distancing of the second end from the first end determines the closing of the arm and the consequent passage of the housing body into the first position, and the nearing of the second end to the first end causes the opening of the arm and the consequent passage of the housing body into the second position.

Preferably, the activating member is an electromechanical linear actuator (for example a solenoid actuator), electric (for example a linear motor), pneumatic (for example a cylinder) or hydraulic.

Preferably, as shown in FIGS. 1, 1a and 2, the articulated structure comprises a plurality of arms 22, preferably identical to one another and to the arm. The articulated structure preferably comprises four arms connecting four sides, two by two and opposite, of the housing body and the platform. By way of example, the four arms are arranged circumferentially about the connecting body, the arms preferably being staggered by 90° to one another and each arm is facing the opposite arm.

Preferably, as shown by way of example in FIGS. 2b and 2c, the activating member 30 has the first end 31 fixed to the platform and the second end 32 connected externally to the lower rod 24 of a respective arm 22, preferably by means of special rotating joints (for example hinges), and the translating motion of the second end with respect to the first end occurs in a substantially vertical direction.

In this way the vertical movement of the housing body can be obtained, which determines the passage between the first and the second position in an effective way, and to increase the vertical run of the housing body as the activating member is external of the articulated structure and does not obstruct the internal space, enabling the arms 22 to close completely in the first position.

By way of example, the delivering members comprise two distinct activating members 30 positioned symmetrically in the articulated structure and activating, in a synchronised way, two opposite and facing arms.

The base preferably comprises a fixed support 4 and translating members mounted to the fixed support and bearing the platform; the translating members being structured such as to horizontally move the platform between a third position, in which it is neared to the fixed support, and a fourth position, in which it is distanced from the fixed support.

When in the third position, the platform is preferably positioned in such a way as to receive a product from the store of the vending machine and, when in the fourth position, it is positioned such as to launch the product into a launch conduit 80.

The characteristics of the launch conduit 80 emerge with greater clarity in the following.

Preferably the housing body 5 has a rectangular plan conformation (preferably bevelled at the corners), circular, oval or polygonal, and comprises a bottom and one or more lateral walls defining the cavity.

Preferably, as shown by way of example in FIG. 1, the conduit has a transversal section that coincides with the plan of the housing body, i.e. the conduit is complementarily shaped with the housing body. In this way, for example when the platform is in the fourth position, the housing body is located internally of the conduit without any clearance between it and the internal surface of the conduit, preferably in contact with the internal surface of the conduit.

The translating members preferably comprise a respective actuator 15.

Preferably, as shown by way of example in FIG. 2, the actuator is a bolt and screw nut actuator, comprising a screw 16 having a longitudinal axis, a male thread and fixed to an end of the fixed support 4, a motor (not shown, for example of known type and preferably positioned on the fixed support) destined to set in rotation the screw about the longitudinal axis thereof, and at least a support bar 18 having a respective longitudinal axis, parallel to the longitudinal axis of the screw, fixed at an end to the fixed support, where the platform 3 comprises a screw nut 19 provided with a main hole 19a, crossing the screw nut and having a female thread, in which the screw is inserted in such a way that the male thread couples with the female thread, and at least a second hole 19b, crossing the screw nut, in which the support bar is inserted.

The motor is preferably structured such as to set the screw in rotation and to determine the translation of the screw nut and consequently of the platform along the longitudinal axis of the screw.

The screw-screw nut actuator preferably comprises a pair of support bars 18 located at sides of the screw and the screw nut is provided with a corresponding pair of secondary holes 19b in each of which a respective support bar is inserted.

In an embodiment shown by way of example in FIGS. 2a and 2c, the actuator of the translation members is a telescopic actuator 34 comprising one or more telescopic arms 35 each comprising a first body 36, having a first end fixed to the fixed support 4 and a second end, and a second body 37, having a first end fixed to the fixed support 4 and a second end, and a second body 37, having a first end slidably inserted (for example in a guide, not illustrated) in the second end of the first body and a second end to which the platform 3 is fixed. The second body preferably slides parallel to the first body in such a way as to vary the overall longitudinal extension of the telescopic arm. When the second body is completely inserted in the first body, the platform is preferably in the third position and when the second body is completely extracted from the first body the platform is in the fourth position.

Preferably, the telescopic actuator 34 comprises a pinion 38, fixed to the fixed support or to the first body of a telescopic arm and set in rotation by a respective motor (not shown, for example of known type), and a rack 39 enmeshing with the pinion and solidly constrained (for example inferiorly) to the platform, such as to determine the lengthening or shortening of the one or more telescopic arms 35 and consequently the translation of the platform from the third to the fourth position.

The Applicant has found that the use of a translating member in the form of a telescopic actuator (or retracting actuator) advantageously enables obtaining a complete retraction of the whole device (i.e. of the entire base 2, all the delivering members 20 and the housing body 5) from the fourth to the third position. In other words, the translation movement from the third to the fourth position (intended to arrange the articulated structure 21 at the launch conduit and the initial point of the launch trajectory) and the subsequent return from the fourth to the third position is achieved without the use of members taking up a space, internally of the vending machine, additional to the space occupied by the device in the third position.

The total retraction of the device by means of telescopic arms enables freeing up the whole launch conduit, which can be advantageously closed, such as to maintain the inside of the vending machine isolated from the external environment, and open only at the moment of delivering. The technical feature of closing and opening the launch conduit, and the relative advantages, will become clear from the following description.

The telescopic actuator 34 preferably comprises two telescopic arms 35 located at the sides of the platform, and the rack is fixed to a central portion of the platform and is interposed between the telescopic arms. This enables increasing the stability of the translation members, the platform and the articulated structure.

Alternatively, in an embodiment that is not illustrated, the actuator 15 is a linear motor comprising a stator, fixed to the fixed support, and a rotor, slidably associated to the stator and bearing the platform. In an aspect, the linear motor is structured such as to determine the translating of the stator and consequently the passage of the platform between the third and the fourth positions.

Also alternatively, in an embodiment that is not illustrated, the actuator of the translation members is a belt actuation comprising a motor, fixed to the fixed support, a drive pulley, set in rotation by the motor, a driven pulley, fixed to the fixed support and free to rotate, and a belt (preferably cogged) wound about the drive and driven pulleys and bearing the platform, such as to determine a translation of the platform along a perpendicular axis to the rotation axis of the motor and the pulleys.

In a further possible embodiment of the device 1, shown by way of example in FIGS. 3, 3a and 4, the base 2 comprises a fixed fulcrum 6 and the housing body 5 has a longitudinal development axis 5b and comprises a first housing 7a at a first end, a second housing 7b at a second end longitudinally opposite the first end, and an anchoring point 7c interposed between the first and second ends and movably fixed to the fulcrum in such a way that the housing body can rotate, in the anchoring point 7c, about an oscillating axis 8 that is transversal (preferably perpendicular) to the longitudinal development axis, determining the inclination of the longitudinal development axis with respect to the horizontal.

Preferably, when the housing body is in the first position and receives a product, the product is received in the first housing and taken to the second housing.

Preferably, the rotation of the housing body about the fulcrum determines the raising of the first housing and the lowering of the second housing or the lowering of the first housing and the raising of the second housing.

Preferably, when the housing body is in the first position the first housing is higher than the second housing and when the housing body is in the second position the second housing is higher than the first housing. In this configuration, the housing body in the first position is inclined such as to receive the product in the first housing and cause sliding thereof into the second housing by effect of gravity (the housing body is structured such as to function as a chute for the passage from the first to the second housing body).

The housing body is preferably realised in a single piece and assumes, as shown by way of example in FIGS. 3 and 4, an overall “tray” shape.

Preferably, the first housing is destined to be positioned in the vending machine in such a way as to receive the products from the store 120 of the machine and the second housing is destined to be positioned in the machine in such a way as to position the product at the start of the launch trajectory. The housing body preferably has a substantially equal width to that of the store (or the width of the, shelves of the store), for example taken parallel to the oscillating axis. In this way the housing body is able to receive products coming from each shelf, row or compartment of the store, without any need to predispose the chute 135 destined to convey the products into the housing body.

Preferably, when the housing body passes from the first to the second position, the inversion of inclination of the housing body and the consequent raising of the second housing determines the detachment of the product from the second housing and the launch of the product along the launch trajectory. The launch of the product from the second housing preferably takes place in an appropriate launch conduit 80.

Preferably, the launch conduit and the outlet mouth have a substantially equal width to the housing body or the store (for example the width of the shelves of the store). In this configuration, the product falls into the housing body along the vertical from the position thereof in the store and it does not have to be conveyed to the centre of the housing body, as the launch conduit has a width that is at least equal to the housing body and the launch can occur along any trajectory comprised in the width of the housing body.

Preferably, the delivering members 20 comprise an actuating member 30 fixed to the fulcrum or directly to the vending machine, and acting on the housing body, preferably on the first housing.

Preferably, as shown by way of example in FIGS. 3, 3a and 4, the actuating member acts on the portion of housing body located by the first housing with respect to the fulcrum and positions the housing body in the first position by means of the vertical thrust and in the second position by vertical pulling.

Alternatively the actuating member acts on the portion of the housing body positioned by the second housing with respect to the fulcrum and positions the housing body in the first position by vertical pulling and in the second position by vertical thrust.

In a further possible embodiment, shown by way of example in FIGS. 5a, 5b and 6, the delivering device 1 is destined to be mounted on an elevator 60 (schematically shown, for example of known type) structured to move vertically internally of the vending machine in order to be positioned at the respective level of a shelf 121 of the vending machine in order to receive a product to be delivered on the housing body 5, and to bring the device 1 to the delivering mouth 130 of the vending machine, located in proximity of the top of the machine, where the launch ejection of the product takes place.

The elevator can belong to the device 1 or to the machine 100.

The base 2 preferably comprises a base plate 40 destined to be fixed, preferably horizontally and rigidly, to the elevator 60, and the housing body 5 is positioned superiorly of the base plate.

Preferably the delivering members 20 comprise a mechanism 41, interposed between and connecting the housing body 5 and the base plate 40 and comprising a first rod 42 having a first end 42a that is rotatably hinged to the base plate and a second end 42b longitudinally opposite the first end, rotatably hinged to the housing body 5 and a second rod 43, having a respective first end 43a rotatably and slidably hinged to the base plate and a second end 43b, longitudinally opposite the first end, rotatably hinged to the housing body 5.

Preferably the first rod 42 has the first end 42a hinged to a front portion 40a of the base plate and the second end 42b hinged to a rear portion 5d of the housing body, and the second rod 43 has the first end 43a thereof inserted in a guide (preferably a grooved guide) on a rear portion 40b of the base plate and the second end 43b hinged on a front portion 5c of the housing body, such that the rods are crossed (in correspondence of a respective central portion) and define a mobile four-bar linkage.

It is observed that, of the four ends of the rods (which define the ends of the bar linkage), the first end 43a of the second rod 43 has two degrees of liberty, one of which is rotational (about the point at which it is hinged to the base plate) and the other of which is translational (internally of the guide), while the remaining three ends 42a, 42b and 42b have only one degree of liberty, rotational (about the respective point at which they are hinged to the base plate or the anchoring body).

In practice, the position of the first end 43a of the second rod, hinged slidably to the guide 44, can vary by translation in the guide, while the position of the second end of the first rod and the second end of the second rod, with respect to the housing body, remains unchanged and the position of the first end of the first rod, with respect to the base plate, also remains unchanged. Following the translation of the first end of the second rod in the guide, the remaining three ends of the guides rotate about the fixed point thereof, determining a rototranslations of the housing body. The mobile four-bar linkage has a mechanism that is such that when the first end 43a of the second rod is positioned at the end of the guide further from the first end 42a of the first rod (i.e. the delivering members are in the rest configuration) the housing body is in the first position (substantially parallel to the base plate) while a translation in the guide of the first end of the second rod nearing the first end of the first rod (i.e. the delivering members are brought into the launch configuration) determines a raising of the second end of the first rod and thus an inclination of the housing body with respect to the base plate, the housing body moving into said first position.

Preferably the mechanism 41 comprises a central constraint between the first and second rods, which creates a mobile connection of the rods in the respective crossing portions and comprises a longitudinal groove 45 afforded in the first (as shown by way of example in FIG. 6) or second rod between the respective first and second ends and a pivot fixed, respectively, to the second or first rod and slidably inserted in the longitudinal groove.

Preferably the first rod 42 has a length that is greater than or equal to the respective length of the second rod 43, where the lengths are calculated as the distance between the respective first and second ends.

The delivering members preferably comprise at least a respective actuating member (not shown, for example of known type or of the above-described type) operatively connected to the mechanism and structured such as to determine the above-described passage between the rest configuration and the launch configuration.

Preferably the actuation member has a first end fixed to the base plate and a second end, opposite the first end, connected to the housing body, preferably by means of suitable rotating joints (for example hinges), and the distancing or nearing of the second end to and from the first end determines the rototranslating movement of the housing body according to the mechanism of the four-bar linkage. In practice, following the movement of the actuating member, the respective ends of the first and second rods rotate in the above-described way and, in addition, the first end of the second rod translates in the guide.

Alternatively, the actuating member can directly activate an end of the first or the second rod, determining the movement of the entire mechanism. By way of example, the actuating member is active on the first end of the second rod and causes it to translate in the guide as described above.

Preferably (not illustrated) the mechanism is interposed between the base plate and the housing body in an intermediate position along a main development direction of the base.

Alternatively (as shown by way of example in FIG. 6) the delivering members comprise a pair of mechanisms 41, preferably identical to one another, interposed between the base plate 40 and the housing body 5 at the respective opposite sides corresponding to the base plate and the housing body.

The applicant believes that a delivering device according to one or more of the aspects and/or the embodiments described can advantageously be mounted on known-type vending machines, new or already in use, with the aim of modifying the delivering of products, or can be integrated in a special vending machine, newly designed and realised.

Further, the Applicant feels that the device of the present invention, by delivering the product by launch ejection of the product directly to the outside of the vending machine, enables guaranteeing the security of the vending machine comprising the device against intrusion or non-authorised access to the product store or other internal parts of the machine.

In a possible embodiment (not illustrated), for example for the delivering of lightweight goods, the delivering members comprise generating members of a jet of compressed air and a nozzle structured such as to orientate the jet of compressed air in such a way as to determine the launch ejection of the product from the housing body to the outside of the vending machine along the launch trajectory.

The delivering device preferably comprises an electronic control board programmed to manage functioning thereof, for example in order to activate and control the delivering members.

Within the scope of the present invention, the above-mentioned launch conduit 80 can be a part of the delivering device 1 or the vending machine 100.

The launch conduit 80 is preferably structured to contain the product at least for a portion of the launch trajectory, preferably at least during the ascending fraction.

The launch conduit preferably has a circular, oval, rectangular or polygonal transversal section, which section is constant over a whole longitudinal length thereof, or variable, preferably continuously, along the longitudinal development of the conduit.

In a possible embodiment, shown by way of example in FIGS. 1 and 1a, the launch conduit 80 is mounted externally of the containing body 110 of the machine 100 and comprises a vertical tube 81 having a lower end 82 communicating with the inside of the vending machine 100 and structured to at least partially house the delivering device and enable passage of the housing body between the first and the second positions, and an open upper end 83 exhibiting the delivering mouth 130. The lower end of the tube preferably has a substantially horizontal conformation and is structured to enable passage of the base between the third and the fourth positions.

Preferably, as shown in FIG. 1a, the lower end 82 of the launch conduit comprises a bottom portion 82a extending inferiorly beyond the space occupied by the platform 3 when it is in the fourth position. In the case of introduction, for example accidentally, of a foreign object from the delivering mouth internally of the conduit, the bottom portion advantageously enables preventing the object from remaining in an obstructing position to the movement of the platform between the third and fourth positions. The bottom portion preferably comprises an inspection hatch (not shown) for access to the inside of the conduit.

In a further possible embodiment, the launch conduit 80 can be positioned internally of the vending machine and comprise an external wall 84, preferably coinciding with the front wall 112, and an internal wall 85 defining between them a space in the conduit 86 communicating inferiorly with the inside of the vending machine, and superiorly joined to form the delivering mouth 130.

In a possible embodiment, the launch conduit is applied to the outside of a known-type machine of a front wall at the base of which an opening is found for a usual collecting drawer. In this case the drawer is eliminated and the product is launched from the opening in the launch conduit, which is made up also by the pre-existing front wall. In this way the front wall of the vending machine maintains its function of heat insulation and anti-intrusion. Preferably, for example in the embodiment of FIGS. 3, 3a and 4, the delivering members are structured such as to determine the positioning of the housing body in the second position in such a position as to give the product a launch trajectory having a determined inclination. In particular, the passage of the delivering members into the launch configuration causes a rotary motion of the housing body from the first to the second position, which motion causes a tangential detachment of the product, with respect to the circumference defining the rotary motion, at the second housing. In this configuration, the trajectory is straight and preferably inclined with respect to the vertical, so the launch conduit may not be curved and it is not necessary that the product be guided by dragging along the launch conduit up to the outlet mouth; the product can therefore exit advantageously without touching the walls of the launch conduit.

The launch conduit can alternatively be appropriately conformed (for example with an inclination towards outside the machine) such that the launch trajectory, preferably a portion of the ascending fraction of the launch trajectory, is tangential to an internal surface of the conduit from a tangent point up to the delivering mouth. In this way, during the launching of the product, there might be impacts between the product and the walls of the launch conduit, which might determine a breakage of the machine, for example of the conduit itself, and compromise the integrity of the product or degrade its characteristics, or even prevent completion of the correct launch trajectory.

The delivering mouth 130 of the launch conduit 80 preferably exhibits a plurality of undulating portions 87 each defining a respective outlet pathway, the trajectory passing through one of the outlet pathways. In this way it is possible to vary, preferably at each delivering, the trajectory described by the delivered product, with the aim of making the exit of the product random and thus increase the level of attention of the user with regard to the trajectory of the product.

In an aspect, the machine comprises a closing member 70, operatively associated to the launch conduit such as to operate between a closed configuration, in which it completely occupies an internal section of the launch conduit, preferably air-sealing the inside of the machine from the outside of the machine, and an open configuration in which it preferably in no way obstructs the internal section of the launch conduit.

In an aspect, the delivering member is normally closed and, at the moment of the launch delivering, is brought into the open configuration such as to enable passage of the product internally of the conduit and the exit thereof from the vending machine.

In this way the inside of the machine can be kept isolated, in particular thermally isolated, from the external environment. In fact, the inside of the machine is typically refrigerated, with the aim of conserving the products (for example food products) contained in the store. The presence of the closing member prevents an increase in the internal temperature of the machine, caused by the passage of air between the outside and the inside of the machine through the launch conduit, which might lead to a deterioration in the products. Further, the permanent closing of the conduit, with the exception of the delivering moments, enables preventing the undesired inlet of external agents, for example dust and contaminants.

By “internal section” of the conduit is meant a transversal section, preferably horizontal or perpendicular to the longitudinal development of the conduit, which identifies the internal area of the conduit.

Preferably, as shown by way of example in FIG. 3a, the closing member is structured in such a way as to enable all the delivering device not to be translated towards the outside (for example in the lower part of the launch conduit) such as to perform the launch of the product, but to let it remain fixed internally of the vending machine. In this configuration, when the closing member is in the open configuration, it enables the movement of the housing body and the launch of the product into the launch conduit while, when it is in the closed configuration, it closes the conduit without interfering with the delivering device (typically with the housing body). The closing member preferably has an L section and comprises a bend between the end to which it is hinged and the opposite end of the closing conduit. The closing member is preferably hinged to the base of the machine.

In an aspect, in the closed configuration the closing member entirely obstructs the launch conduit and in the open configuration it leaves the conduit at least partially open and does not intercept the launch trajectory.

Preferably (the portion of bottom of) the lower end of the launch conduit can be inferiorly open towards the outside of the machine. In this way an extraneous object introduced from the delivering mouth internally of the launch conduit can be prevented from staying in the conduit and obstructing the launch of the products. In this case, the heat insulation and the inaccessibility of the inside of the vending machine are advantageously guaranteed by the closing members.

The closing member 70 is preferably a hatch activated by suitable movement means, not shown and for example of known type.

In the embodiment of FIG. 1a, the closing member passes between the open configuration and the closed configuration by means of a translation of the lower end 82 of the launch conduit 80.

In the embodiments of FIG. 3a and FIGS. 5a and 5b, the closing member passes between the open configuration and the closed configuration by means of a rotation, respectively at the lower end 82 and upper end 83 of the launch conduit 80, with respect to a fulcrum at an end of the closing member, for example placed on the launch conduit itself.

1. A device (1) for delivering products from a vending machine (100), comprising:
a base (2) destined to be mounted to the vending machine;
a housing body (5) movably mounted to said base and destined to receive, at a first vertical height (11), a product (10) to be delivered;
delivering members (20) interposed between said base and said housing body and structured for moving said housing body in order to determine the delivering of the product,
wherein the delivering of the product takes place by means of a launch ejection of the product outside said vending machine along a launch trajectory which passes through a second vertical height (12) that is higher than said first vertical height.

2. The device (1) of claim 1, wherein said housing body (5) is mobile between a first position, in which it receives and houses a product, and a second position, distinct from the first position, and wherein said delivering members (20) are structured for passing between a rest configuration, in which the delivering members (20) position the housing body in said first position, and a launch configuration, in which the delivering members (20) position the housing body in said second position, the passage of said members between said rest configuration and said launch configuration occurring substantially in a sudden way in such a way that the product moves away from the housing body in order to perform the delivering, where the passage of said delivering members (20) from the rest configuration to the launch configuration determines a substantially immediate detachment of the product housed in the housing body (5) and a motion thereof along said launch trajectory, with a consequent exit of the product from the vending machine, said launch trajectory comprising an ascending fraction having an initial point lying on the housing body and a terminal point and passing through, or having said terminal point at, said second vertical height (12), and a descending fraction, subsequent to and continuous with said descending fraction, having an initial point coinciding with the terminal point of said ascending fraction and a respective terminal point external of the vending machine and at a lower vertical height than said second vertical height.

3. The device (1) of claim 1, wherein said base (2) comprises a horizontal platform (3) bearing said delivering members (20), on which said housing body (5) is mounted in a higher position than said base, a fixed support (4) and translating members mounted on said fixed support and bearing said platform (3), the translation members being structured for horizontally moving the platform between a third position, in which it is neared to the fixed support, and a fourth position, in which it is distanced from the fixed support, wherein the platform, when it is in said third position, is positioned in such a way as to receive a product from a store of the vending machine and, when it is in said fourth position, it is positioned in such a way as to launch the product into a launch conduit (80).

4. The device (1) of claim 3, wherein said translation members comprise a respective actuator (15), said actuator being a telescopic actuator (34) comprising one or more telescopic arms (35) each comprising a first body (36), having a first end fixed to said fixed support (4) and a second end, and a second body (37), having a first end slidably inserted in said second end of the first body and a second end to which said platform (3) is fixed, wherein the second body translates parallel to the first body in such a way as to vary the overall longitudinal extension of the telescopic arm, wherein when the second body is completely inserted in the first body the platform is in said third position and when the second body is completely extracted from the first body the platform is in said fourth position.

5. The device (1) of claim 1, wherein the base comprises a fixed fulcrum (6) and the housing body (5) has a longitudinal axis of development (5b) and comprises a first housing (7a), at a first end, a second housing (7b), at a second end longitudinally opposite to said first end, and an anchoring point (7c) interposed between said first end and said second end and movably fixed to said fulcrum in such a way that the housing body can rotate, in the anchoring point, about an oscillation axis (8) that is transversal to the longitudinal axis of development, determining the inclination of the longitudinal axis of development with respect to the horizontal, wherein, when the housing body passes from the first to the second position, the inversion of inclination of the housing body, and the consequent raising of the second housing, determines the detaching of the product from the second housing and the launching of the product into a launch conduit (80) along said launch trajectory.

6. The device (1) of claim 1, wherein the passage of the delivering members between a rest configuration and a launch configuration determines a vertical translation of the housing body respectively nearingly to and distancingly from said base (2), and wherein the delivering members comprise an articulated structure (21), connecting said base (2) and said housing body (5), and at least an actuating member (30) operatively connected to said articulated structure and structured for determining the aforesaid passage between the rest configuration and the launch configuration, said articulated structure comprising at least an arm (22) comprising an upper rod (23), a lower rod (24) and a central hinge (25), wherein the upper rod has an upper end (23a) hinged to the housing body and a lower end (23b) hinged to said central hinge, and the lower rod has a respective upper end (24a) hinged to said central hinge and a respective lower end (24b) hinged to said base.

7. The device (1) of claim 1, destined to be mounted on an elevator (60) structured for moving vertically internally of the vending machine in order to be positioned at a respective level of a shelf (121) of a store (120) of the vending machine, such as to receive, on said housing body (5), a product (10) to be delivered, and in order to bring the delivering device in correspondence of a delivering mouth (130) of the vending machine, located in proximity of the top of the vending machine, where the launch ejection of the product takes place, wherein the base comprises a base plate (40) destined to be fixed, preferably horizontally and rigidly, to the elevator (60), and the housing body is positioned superiorly of the base plate, and wherein the delivering members comprise a mechanism (41), preferably a mobile four-bar linkage, interposed between, and connecting, the housing body and the base plate and structured for determining the passage of the housing body between a first and a second position.

8. The device (1) of claim 1, comprising a launch conduit (80) structured for containing the product at least for a portion of said launch trajectory, preferably at least during an ascending fraction, wherein the launch conduit is mounted externally of the vending machine and comprises a vertical tube (81) having a lower end (82) communicating with the inside of the vending machine and structured for housing, at least partially, the delivering device (1) and for enabling the passage of the housing body (5) between a first and a second position, and an open upper end (83) exhibiting a delivering mouth (130), or wherein the launch conduit is positioned internally of the vending machine and comprises an external wall (84) and an internal wall (85) which between them define a space of the conduit (86), communicating inferiorly with the inside of the vending machine, and which are superiorly joined to form said delivering mouth (130).

9. A vending machine (100) of products, comprising:
a containing body (110);
a store (120) positioned in said containing body (110) and structured for removably housing a plurality of products (10);
a delivering mouth (130) placing the inside of the vending machine in communication with the outside and preferably placed in proximity of the top of the vending machine;
a device (1) for delivering products according to claim 1, positioned in said containing body (110) and structured for receiving from the store, at the first vertical height (11), a product to be delivered and for delivering the product by launch ejection of the product from said delivering mouth (130) to the outside of the vending machine along a launch trajectory passing through the second vertical height (12) that is higher than said first vertical height.

10. A method for delivering products from a vending machine, the method comprising the steps of:
a) receiving, at a first vertical height (11), a product (10) to be delivered from a store (120) of the vending machine;
b) delivering the product by launch ejection of the product itself externally of the vending machine along a launch trajectory that passes through a second vertical height (12) that is higher than said first vertical height.
